(19) United States
(12) Patent Application Publication
(10) Pub. No.: US 2016/0355238 A1
(43) Pub. Date: Dec. 8, 2016

(54) SEAT BASE

(71) Applicant: JANKEL ARMOURING LIMITED, Weybridge Surrey (GB)

(72) Inventor: Eric CHARLESTON, High Wycombe, Buckinghamshire (GB)

(21) Appl. No.: 15/108,040

(22) PCT Filed: Dec. 22, 2014
(86) PCT No.: PCT/GB2014/053828

§ 371 Date: Jun. 24, 2016

(30) Foreign Application Priority Data
Dec. 27, 2013 (GB) 1323067.7

(51) Int. Cl. B63B 29/06; B60N 2/54; B60N 2/50; A47C 7/00; B63B 29/04

(52) U.S. Cl. CPC B63B 29/06; A47C 7/002; B63B 29/04; B60N 2/502; B60N 2/546; B63B 2029/043

(57) ABSTRACT

The present invention relates to a seat base (10) comprising a first mounting surface face (12) adapted to couple a seat to the seat base (10); a second mounting surface (14) adapted to couple the seat base (12) to a surface of a small marine vessel; and a spring/damper assembly (20) positioned between and connected to the first and second mounting surfaces (12, 14). The spring/damper assembly (20) comprises at least one spring/damper element (22), the at least one spring/damper element comprising a first flexible member (24) having a first end connected to the first mounting surface (12) and a second flexible member (26) having a first end connected to the second mounting surface (14) and a second end coupled to a second end of the first flexible member (24).

The present invention relates to a seat base, in particular, a seat base for a small marine vessel.

The present invention also relates to a seat base that attenuates the shock and vibration generated by vehicles whether on land, water or air.

The present invention also relates to a seat assembly comprising a seat base in accordance with the present invention.

In small marine vessels, such as a motorboat or a speedboat, a user and/or passenger is much closer to the waves. As a result, he/she is more likely to feel the effects of the waves on the vessel.

In calm waters or travelling at low speed, the effects of the wave on the vessel when translated to the user/passenger are at a tolerable level. However, in turbulent waters or travelling at high speeds, these effects can be unbearable.

Similarly in land vehicles, when travelling in calm terrain or at lower speeds the seated occupant experiences shock and vibration at a tolerable level. However in rough terrain, and/or at higher speeds, these effects can be unbearable.

It is an object of the invention to provide a seat base for a small marine vessel which cushions and/or reduces the transfer of the effect of the waves on the vessel to a seated user/passenger.

It is also an object of the invention to provide a seat base that is capable of attenuating the shock and vibration generated by vehicles whether on land, water or air.

According to a first aspect, there is provided a seat base comprising:
a first mounting surface adapted to couple a seat to the seat base;
a second mounting surface adapted to couple the seat base to a surface of a small marine vessel; and
a spring/damper assembly positioned between and connected to the first and second mounting surfaces;
wherein the spring/damper assembly comprises at least one spring/damper element, the at least one spring/damper element comprising a first flexible member having a first end connected to the first mounting surface and a second flexible member having a first end connected to the second mounting surface and a second end coupled to a second end of the first flexible member.

By means of the invention, a seat base which will respond to the impact of the wave motion on the vessel and cushion and/or reduce the transfer of the effect of the waves on the vessel to a seated user/passenger is provided.

In addition, the seat base will respond to fore/aft motion as well as to vertical and lateral motion of the vessel, thus providing an advantage over current seat base designs.

This is because current typical shock mitigating seats, as used in the marine environment, have a spring/damper system which predominately protects in the vertical direction, with little or no fore/aft and lateral protection.

Preferably, the second end of the second flexible member is rotatably or rigidly coupled to the second end of the first flexible member.

In exemplary embodiments, the spring/damper assembly comprises a plurality of spring/damper elements. Preferably, two or more of the plurality of spring/damper elements are radially spaced from each other or arranged in parallel with each other.

In a preferred embodiment, the first and/or second flexible members comprise a plurality of elongate leaves. The plurality of elongate leaves act in a similar fashion to a leaf spring and will absorb the impact of the wave motion and dampen the transfer of the impact to a seated user.

Preferably, the first and second flexible members are of identical or similar lengths to one another.

Another disadvantage of current typical shock mitigating seat designs is that they comprise a fixed hinge location and as such have a fixed roll centre.

By having the first and second flexible members being of identical or similar lengths, the first and second flexible members will be coupled to each other at or proximate the middle of the spring/damper element. This results in the absence of a fixed roll centre and allows the seat base to move freely in horizontal, vertical, lateral directions and combinations of these. Thus ensuring that the seat base reacts to whichever direction the shock/vibration comes from.

The plurality of elongate leaves may comprise any suitable material. Preferably, the plurality of elongate leaves comprise a non-composite or composite material.

In embodiments wherein the plurality of elongate leaves comprise a composite material, it is preferred that the composite material comprises glass fibre, carbon fibre or aramid fibre, eg Kevlar® (i.e. poly paraphenylene terephthalamide), based composites.

In embodiments wherein the plurality of elongate leaves comprise a non-composite material, it is preferred that the non-composite material comprises a metallic material.

Some of the plurality of elongate leaves are conveniently damped within their construction. The arrangement will vary according to the spring/damping characteristics required for the respective application.

In exemplary embodiments, the first and/or second mounting surface is defined by a mounting plate.

Preferably, the mounting plate comprises a metallic material.

In embodiments wherein the mounting plate comprises a metallic material, preferably the metallic material comprises stainless steel, aluminium or titanium.

The second end of the second flexible member may be coupled to the second end of the first flexible member by any suitable means which allows at least one degree of movement between the second ends of the first and second flexible members. Preferably, the second end of the second flexible member is rotatably coupled to the second end of the first flexible member by a device which allows movement in any direction around a fixed point, for example by means of a hinge arrangement, metal elastic bushes, etc. Alternatively, the coupling may be rigid so as to allow the flexible members to twist and provide freedom of movement.

In exemplary embodiments, the second end of the second flexible member is coupled to the second end of the first flexible member by a hinge arrangement.

Optionally, the hinge arrangement comprises a spherical ball bearing or it may be rigid.

In exemplary embodiments, the hinge arrangement comprises a metallic material. Preferably, the metallic material comprises stainless steel, aluminium or titanium.

According to a second aspect, there is provided a seat assembly for a small marine vessel comprising a seat base in accordance with the first aspect of the invention and a seat attached to the seat base.

Preferably, the seat comprises a backrest.

Preferably, the seat is a padded seat.

The invention will now be described by way of non-limiting example, with reference being made to the accompanying drawings, in which:

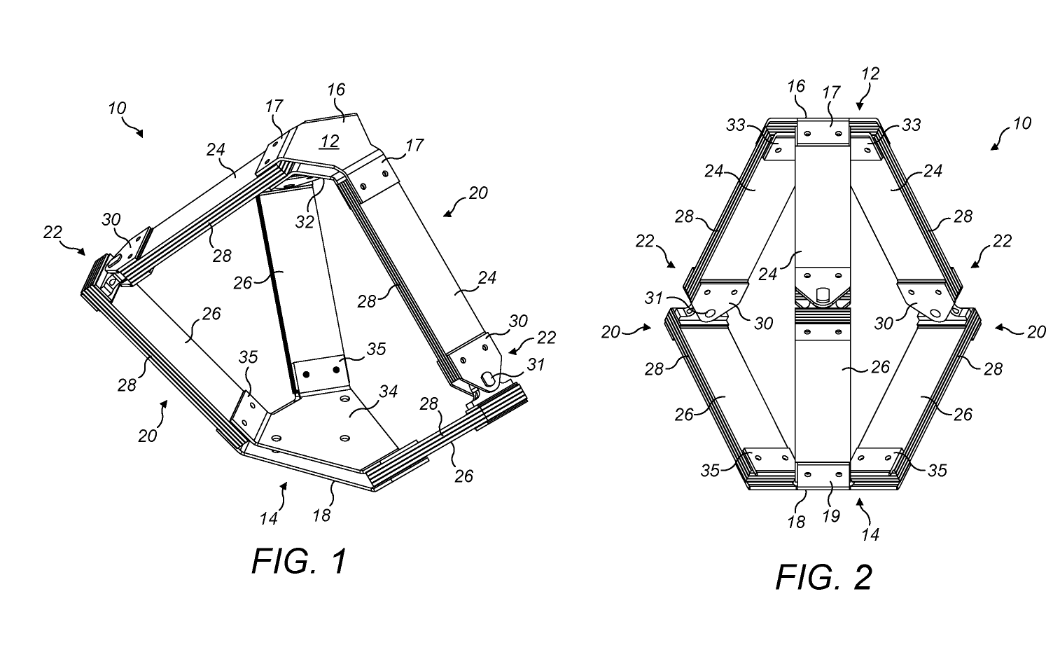

FIG. 1 is a schematic view of a first embodiment of seat base in accordance with a first aspect of the present invention;

FIG. 2 is a front view of the seat base of FIG. 1;

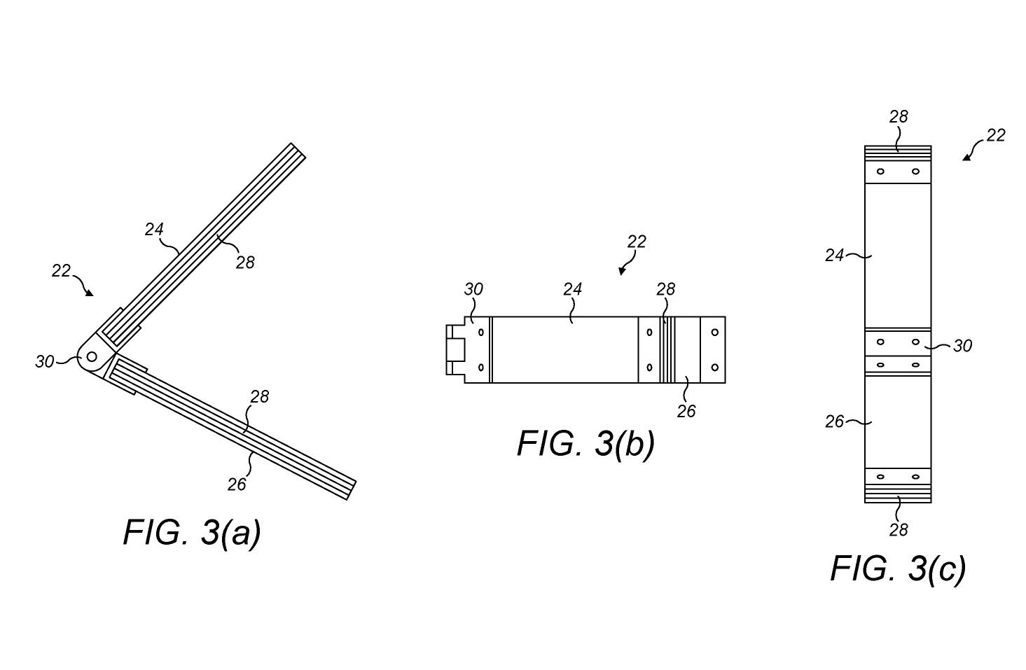

FIG. 3 is a schematic view of a spring/damper element forming part of a seat base in accordance with a first aspect of the present invention;

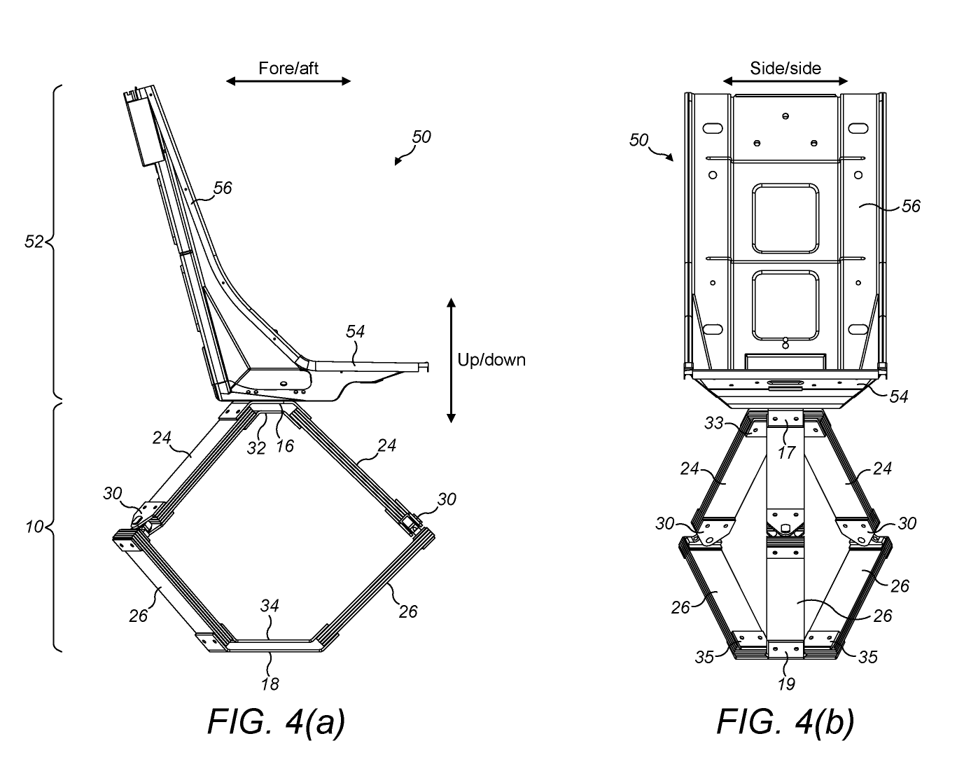

FIG. 4 depicts an embodiment of a seat assembly in accordance with a second aspect of the invention comprising the seat base of FIG. 1;

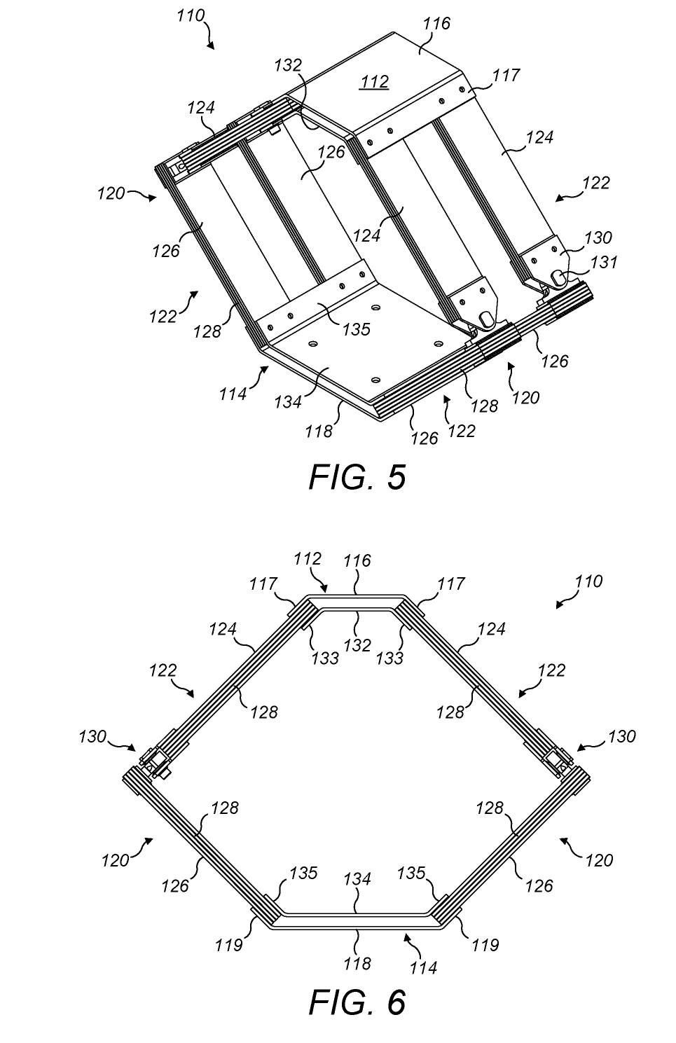

FIG. 5 is a schematic view of a second embodiment of the seat base in accordance with a first aspect of the present invention;

FIG. 6 is a side view of the seat base of FIG. 5; and

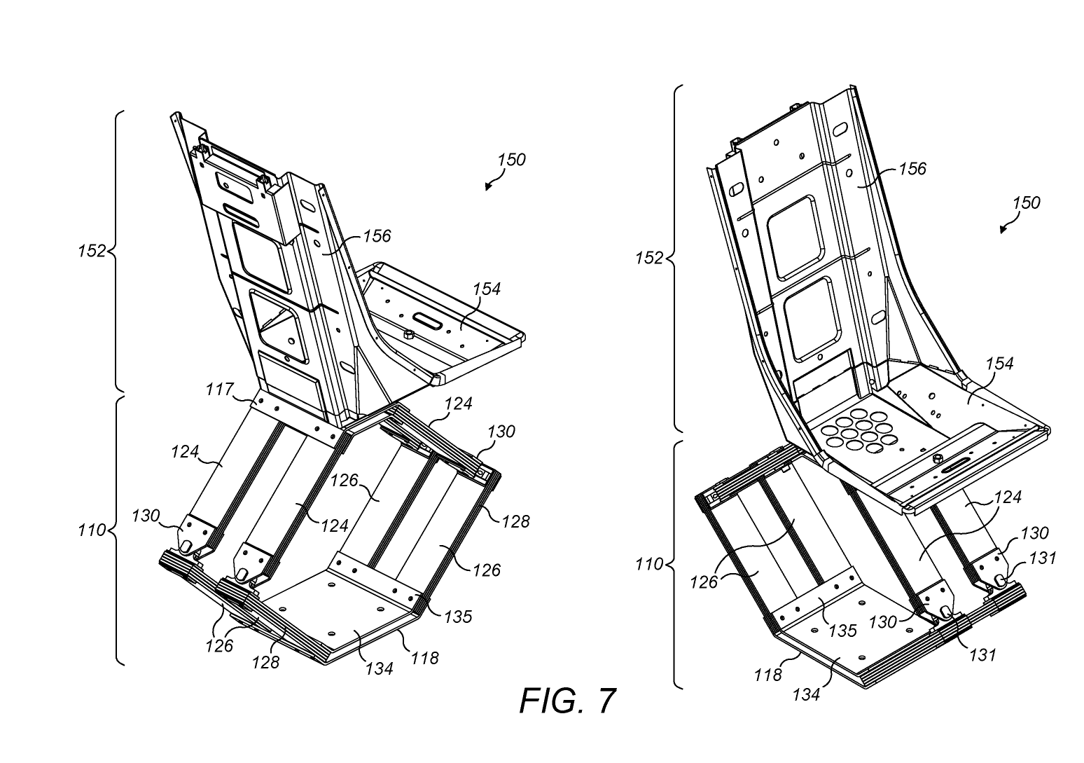

FIG. 7 depicts an embodiment of a seat assembly in accordance with a second aspect of the invention comprising the seat base of FIG. 5.

The preceding discussion of the background to the invention is intended only to facilitate an understanding of the present invention. It should be appreciated that the discussion is not an acknowledgement or admission that any of the material referred to was part of the common general knowledge as at the priority date of the application.

Throughout the description and claims of this specification, the words “comprise” and “contain” and variations of those words, for example “comprising” and “comprises”, mean “including but not limited to”, and are not intended to (and do not) exclude other components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics, compounds described in conjunction with a particular aspect, embodiment or example of the invention are to be understood to be applicable to any other aspect, embodiment or example described herein unless incompatible therewith.

Referring to FIGS. 1 and 2, a first embodiment of a seat base 10 for a small marine vessel in accordance with the invention is shown.

The seat base 10 comprises a first mounting surface 12 adapted to couple a seat (not shown) to the seat base 10 and a second mounting surface 14 adapted to couple the seat base 10 to a surface of a small marine vessel (not shown) such as the deck of the vessel.

In the embodiment shown, the first and second mounting surfaces 12,14 are each defined by a mounting plate 16,18. While the first and second mounting surfaces 12,14 have been shown as both having an irregular hexagon profile, it should be understood that the mounting surfaces 12,14 may be of different shaped profiles and that the first and second mounting surfaces 12,14 do not need to be of the same shaped profile as each other.

Each mounting plate 16,18 comprises a main body portion defining the mounting surface 12,14 and a flange 17,19 extending from three non-adjacent sides of the main body portion. In the embodiment shown, the flanges 17,19 extend at an angle to the main body portion, however it would be understood that the flanges 17,19 may extend along the same plane as the main body portion.

Each mounting plate 16,18 comprises a metallic material selected from stainless steel, aluminium or titanium. It would be understood that the mounting plates 16,18 may be made of any other suitable material which may be adapted to withstand the environmental conditions acting thereon in use.

The seat base 10 further comprises a spring/damper assembly 20 positioned between and connected to the first and second mounting surfaces 12,14.

The spring/damper assembly 20 comprises at least one spring/damper element 22. In the embodiment shown, the spring/damper assembly comprises three spring/damper elements 22. The spring/damper elements 22 will be referred to as ‘legs’ for clarity and simplicity.

With particular reference to FIG. 3, each leg 22 comprises a first flexible member 24 having a first end connectable to the first mounting surface 12 and a second flexible member 26 having a first end connectable to the second mounting surface 14 and a second end coupled to a second end of the first flexible member 24.

The first and second flexible members 24,26 comprise a plurality of elongate leaves. In the embodiment shown, the first and second flexible members 24,26 each comprise four elongate leaves 28. The plurality of elongate leaves 28 act in a similar fashion to a leaf spring and will absorb the impact of the wave motion and dampen the transfer of the impact to a seated user. Thus the seat base 10 will respond to the impact of the wave motion on the vessel and cushion and/or reduce the transfer of the effect of the waves on the vessel to a seated user/passenger.

In the embodiment shown, each of the leaves 28 of the plurality of elongate leaves comprises a composite material in the form of glass fibre material, although each leaf 28 may comprise any suitable material (composite or non-composite) which will flex and absorb the impact of the wave motion and dampen the transfer of the impact to a seated user.

Alternative suitable composite materials include carbon fibre or aramid fibre, e.g. Kevlar® (i.e. poly paraphenylene terephthalamide), based composites.

The plurality of leaves 28 are encased in resin, with the bulk of them being unidirectional in the plane of the leaves 28 (i.e. parallel with the longitudinal axis of the leaves 28).

In the embodiment shown, the second end of the second flexible member 26 is rotatably coupled to the second end of the first flexible member 24 by a hinge arrangement 30. It should be understood that the second end of the second flexible member 26 may be rotatably coupled to the second end of the first flexible member 24 by any suitable means which allows at least one degree of movement between the second ends of the first and second flexible members 24,26. It should also be understood that while the second end of the second flexible member 26 has been shown to be rotatably coupled to the second end of the first flexible member 24, in alternative embodiments (not shown), the second end of the flexible member 26 is rigidly coupled to the second end of the first flexible member 24.

In the embodiment shown, the hinge arrangement 30 comprises a spherical ball bearing (not shown) and a hinge pin 31.

A center joint is positioned between the first and second flexible members 24,26 that may be articulated or fixed depending on the application and desired degree of torsional rigidity.

The seat base 10 further comprises first and second clamp plates 32,34 which help connect and secure the first ends of the first and second flexible members 24,26 to the first and second mounting surfaces 12,14 in use.

The first and second clamp plates 32,34 are of similar shape to the first and second mounting plates 16,18, and comprise a main body portion and a flange 33,35 extending from three non-adjacent sides of the main body portion. The first ends of the first and second flexible members 24,26 are sandwiched between the respective flanges 17,33;19,35 of the mounting plates 16,18 and clamp plates 32,34.

In the embodiment shown, the three legs 22 are arranged to work both together and independently. In use, the legs 22 of the seat base 10 will flex either together or differentially in response to either the forward or sideways motion of the vessel.

The motion of the vessel at sea will cause the legs 22 to spring/flex in a mainly vertical motion but also in horizontal, lateral and rotational motions. The vertical motion is sprung by all six flexible members 24,26 bending together and springing back with the inbuilt dampers controlling the amount of vibration in the system.

Similarly the horizontal and/or lateral motion works with all six flexible members 24,26 deflecting in a fore/aft and/or lateral motion.

Referring to FIG. 4, an embodiment of a seat assembly 50 in accordance with a second aspect of the invention is shown.

The seat assembly 50 comprises a seat base 10 in accordance with the first aspect of the invention as described above and a seat 52 attached to the seat base 10.

The seat 52 comprises a seating portion 54 and a backrest 56 extending from the seating portion.

The motion of the vessel which the seat base 10 will respond to is indicated by the arrows in FIG. 4, with FIG. 4a depicting a side view of the seat assembly 50 and FIG. 4b depicting a front view of the seat assembly 50.

While the seat 52 has been shown to be in the form of a backrest comprising a backrest 56, it should be understood that the seat 52 may be in any form as known in the art.

Referring to FIGS. 5 and 6, a second embodiment of a seat base in accordance with the first aspect of the invention is shown.

The reference numerals for similar features of the second embodiment to those of the first embodiment have been increased by 100 for convenience. For example, the first flexible member which was indicated by the reference numeral 24 in the first embodiment is now indicated by the reference numeral 124.

As in the first embodiment, the seat base in accordance with the second embodiment comprises a first mounting surface 112 adapted to couple a seat to the seat base 110 and a second mounting surface 114 adapted to couple the seat base 110 to a surface of a small marine vessel.

As in the first embodiment, the first and second mounting surfaces 112,114 are each defined by a mounting plate 116,118. In the embodiment shown, the first and second mounting surfaces comprise a rectangular profile.

Each mounting plate 116,118 comprises a main body portion defining the mounting surface and a flange 117,119 extending from two opposing sides of the main body portion. In the embodiment shown, the flanges extend at an angle to the main body portion, however it would be understood that the flanges 117,119 may extend along the same plane as the main body portion.

Each mounting plate 116,118 comprises a metallic material selected from stainless steel, aluminium or titanium.

Similarly, the seat base 110 further comprises a spring/damper assembly 120 positioned between and connected to the first and second mounting surfaces.

The spring/damper assembly 120 comprises four spring/damper elements (legs) 122. Each leg 122 comprising a first flexible member 124 having a first end connected to the first mounting surface 112 and a second flexible member 126 having a first end connected to the second mounting surface 114 and a second end coupled to a second end of the first flexible member 124.

The first and second flexible members 124,126 are of similar construction to the first and second flexible members 24,26 of the first embodiment.

The second end of the second flexible member 126 is coupled to the second end of the first flexible member 124 by a hinge arrangement 130. The hinge arrangement 130 is of similar construction to the hinge arrangement 30 of the first embodiment.

The seat base 110 further comprises first and second clamp plates 132,134 which help connect and secure the first ends of the first and second flexible members 124,126 in use.

As in the first embodiment, the first and second clamp plates 132,134 are of similar shape to the first and second mounting plates and comprise a main body portion and a flange 133,135 extending from two opposing sides of the main body portion. The first ends of the first and second flexible members 124,126 are sandwiched between the respective flanges 117,133,119,135 of the mounting plates 116,118 and clamp plates 132,134.

In the embodiment shown, four legs 122 are arranged to form two separate diamond forms working both together and independently. In use, the legs 122 of the seat base 110 will flex either together or differentially in response to either the forward or sideways motion of the vessel.

The motion of the vessel at sea will cause the legs 122 to spring/flex in a mainly vertical motion but also in horizontal, lateral and rotational motions. The vertical motion is sprung by all eight flexible members 124,126 bending together and springing back with the inbuilt dampers controlling the amount of vibration in the system.

Similarly the horizontal and/or lateral motion works with all eight flexible members 124,126 deflecting in a fore/aft and/or lateral motion. The rotational motion is achieved by a pair of opposing legs 122 deflecting more than the other adjacent pair of opposing legs 122. The hinge arrangement 130 may have some angular degrees of freedom to allow this to happen.

While the seat base in accordance with the invention has been described with particular reference to its use in a small marine vessel, it should be understood that it is not limited thereto. For example, the seat base in accordance with the invention can be used to attenuate the shock and vibration generated by vehicles, whether on land, water or air.

Furthermore, while the seat base in accordance with the invention has been described with the spring/damper assembly comprising a plurality of spring/damper elements (legs), it should be understood that it is not limited thereto and that the spring/damper assembly may comprise a single spring/damper element.

In addition, while the spring/damper elements have been depicted as being substantially straight, they do not need to be. For example, the legs could be curved.

It will be appreciated also that the spring/damper elements or “legs” are not limited to being straight, or regular in cross-sectional profile, but may have outer cross-sectional profiles including, but not limited to, concave and convex profiles on one or more sides.

1. A seat base comprising:
a first mounting surface adapted to couple a seat to the seat base;
a second mounting surface adapted to couple the seat base to a surface of a small marine vessel; and
a spring/damper assembly positioned between and connected to the first and second mounting surfaces;
wherein the spring/damper assembly comprises at least one spring/damper element, the at least one spring/damper element comprising a first flexible member having a first end connected to the first mounting surface and a second flexible member having a first end connected to the second mounting surface and a second end coupled to a second end of the first flexible member.

2. A seat base according to claim 1, wherein the second end of the second flexible member is rotatably or rigidly coupled to the second end of the first flexible member.

3. A seat base according to claim 1, wherein the spring/damper assembly comprises a plurality of spring/damper elements.

4. A seat base according to claim 3, wherein two or more of the plurality of spring/damper elements are radially spaced from each other or arranged in parallel with each other.

5. A seat base according to claim 1, wherein the first and/or second flexible members comprise a plurality of elongate leaves.

6. A seat base according to claim 5, wherein the plurality of elongate leaves comprise a composite material.

7. A seat base according to claim 6, wherein the composite material comprises glass fibre, carbon fibre, or aramid fibre, e.g. Kevlar®.

8. A seat base according to claim 5, wherein the plurality of elongate leaves comprise a non-composite material.

9. A seat base according to claim 8, wherein the non-composite material comprises a metallic material.

10. A seat base according to claim 1, wherein the first and/or second mounting surface is defined by a mounting plate.

11. A seat base according to claim 1, wherein the second end of the second flexible member is physically coupled to the second end of the first flexible member by a rotatable or rigid arrangement.

12. A seat assembly comprising a seat base in accordance with claim 1, and a seat attached to said seat base.

13. A seat assembly according to claim 12, wherein the seat comprises a backrest.

14. A seat assembly according to claim 12, wherein the seat is a padded seat.
